(19) United States
(12) Patent Application Publication
(10) Pub. No.: US 2024/0200972 A1
(43) Pub. Date: Jun. 20, 2024

(54) METHOD FOR GENERATING INTERSECTION AREA, ELECTRONIC DEVICE, AND STORAGE MEDIUM

(71) Applicant: TENCENT TECHNOLOGY (SHENZHEN) COMPANY LIMITED, Shenzhen (CN)

(72) Inventor: Tongxing XIAO, Shenzhen (CN)

(21) Appl. No.: 18/588,609

(22) Filed: Feb. 27, 2024

Related U.S. Application Data
(63) Continuation of application No. PCT/CN2023/077329, filed on Feb. 21, 2023.

(30) Foreign Application Priority Data
May 31, 2022 (CN) 202210612066.0

(51) Int. Cl. G01C 21/00

(52) U.S. Cl. CPC G01C 21/3815; G01C 21/3867

(57) ABSTRACT

A method for generating an intersection area includes: obtaining road information of a target intersection node; determining road surface width information of roads based on the road information; obtaining a constraint condition and a target function, the target function being configured for indicating a target area size of an intersection area of the target intersection node, the constraint condition being configured for indicating a limiting condition of the target area size and including constraint relationships between corresponding offset variables of every two adjacent roads of at least two roads; determining an offset distance of a road based on the road surface width information of the road, the constraint condition, and the target function; and generating the intersection area of the target intersection node in a map based on the road surface width information of the road and the offset distance of the road.

### CROSS-REFERENCES TO RELATED APPLICATIONS

The present disclosure is a continuation application of PCT Patent Application No. PCT/CN2023/077329, filed on Feb. 21, 2023, which claims priority to Chinese Patent Application No. 2022106120660, filed on May 31, 2022, all of which is incorporated herein by reference in its entirety.

### FIELD OF THE TECHNOLOGY

Embodiments of the present disclosure relate to the field of map and traffic technologies and, in particular, to the field of map data processing.

### BACKGROUND OF THE DISCLOSURE

A map application now can provide a map that replicates a real world as much as possible. The map includes a large quantity of road networks. An intersection area is an area in the map that represents space where an intersection is located. However, due to complexity of road intersections, it is usually difficult to draw a specific intersection area.

An offset distance of each road is usually preset, so that an intersection area of an intersection node is calculated by using a pure geometric algorithm having a large calculation amount. However, due to factors such as an error in a road shape point, mutual coupling of associated geometric conditions, and poor scalability of the pure geometric algorithm, it is impossible to calculate an accurate intersection area by using an existing pure geometric algorithm, especially for some scenarios with complex roads, and the intersection area generated in an electronic map by using the existing pure geometric algorithm is more inaccurate.

### SUMMARY

One aspect of the present disclosure provides a method for generating an intersection area, performed by a computer device. The method includes obtaining road information of a target intersection node, the road information being configured for indicating at least two roads related to the target intersection node; determining road surface width information of roads based on the road information; obtaining a constraint condition and a target function, the target function being configured for indicating a target area size of an intersection area of the target intersection node, the target function including an offset variable corresponding to a road of the at least two roads, the offset variable being configured for indicating a distance between the target intersection node and a tangent line of a corresponding road, the constraint condition being configured for indicating a limiting condition of the target area size, and the constraint condition including constraint relationships between corresponding offset variables of every two adjacent roads of the at least two roads; determining an offset distance of the road based on the road surface width information of the road, the constraint condition, and the target function; and generating the intersection area of the target intersection node in a map based on the road surface width information of the road and the offset distance of the road.

Another aspect of the present disclosure provides a computer device. The computer device includes one or more processors and a memory containing program instructions that, when being executed, causes the one or more processors to perform obtaining road information of a target intersection node, the road information being configured for indicating at least two roads related to the target intersection node; determining road surface width information of roads based on the road information; obtaining a constraint condition and a target function, the target function being configured for indicating a target area size of an intersection area of the target intersection node, the target function including an offset variable corresponding to a road of the at least two roads, the offset variable being configured for indicating a distance between the target intersection node and a tangent line of a corresponding road, the constraint condition being configured for indicating a limiting condition of the target area size, and the constraint condition including constraint relationships between corresponding offset variables of every two adjacent roads of the at least two roads; determining an offset distance of the road based on the road surface width information of the road, the constraint condition, and the target function; and generating the intersection area of the target intersection node in a map based on the road surface width information of the road and the offset distance of the road.

Another aspect of the present disclosure provides a non-transitory computer-readable storage medium including instructions that, when being executed, causes a computer device to perform: obtaining road information of a target intersection node, the road information being configured for indicating at least two roads related to the target intersection node; determining road surface width information of roads based on the road information; obtaining a constraint condition and a target function, the target function being configured for indicating a target area size of an intersection area of the target intersection node, the target function including an offset variable corresponding to a road of the at least two roads, the offset variable being configured for indicating a distance between the target intersection node and a tangent line of a corresponding road, the constraint condition being configured for indicating a limiting condition of the target area size, and the constraint condition including constraint relationships between corresponding offset variables of every two adjacent roads of the at least two roads; determining an offset distance of the road based on the road surface width information of the road, the constraint condition, and the target function; and generating the intersection area of the target intersection node in a map based on the road surface width information of the road and the offset distance of the road.

### BRIEF DESCRIPTION OF THE DRAWINGS

FIG. 1 is a schematic diagram of an application scenario of a method for generating an intersection area according to an embodiment of the present disclosure.

FIG. 2A is a schematic diagram of a single-node intersection according to an embodiment of the present disclosure.

FIG. 2B is a schematic diagram of a compound-node intersection according to an embodiment of the present disclosure.

FIG. 3 is a flowchart of a method for generating an intersection area according to an embodiment of the present disclosure.

FIG. 4 is a schematic diagram of a road after widening according to an embodiment of the present disclosure.

FIG. 5 is a schematic diagram in which tangent lines of a road intersect according to an embodiment of the present disclosure.

FIG. 6 is a schematic diagram of a relationship between offset distances according to an embodiment of the present disclosure.

FIG. 7 is a schematic diagram in which tangent lines do not intersect or intersect at an endpoint of the tangent lines according to an embodiment of the present disclosure.

FIG. 8 is a schematic diagram of an intersection area according to an embodiment of the present disclosure.

FIG. 9 is a schematic diagram of an embodiment of an intersection area generation apparatus according to an embodiment of the present disclosure.

FIG. 10 is a schematic diagram of a hardware structure of an intersection area generation apparatus according to an embodiment of the present disclosure.

### DESCRIPTION OF EMBODIMENTS

In the specific implementation of the present disclosure, specific products or technologies related to user information and other data may be involved. When embodiments of the present disclosure are applied to such specific products or technologies, user permission or consent needs to be obtained, and collection, use and processing of relevant data need to comply with relevant laws, regulations and standards of relevant countries and regions.

The following clearly and completely describes the technical solutions in embodiments of the present disclosure with reference to the accompanying drawings in embodiments of the present disclosure. It is clear that the described embodiments are some but not all of embodiments of the present disclosure. Based on embodiments of the present disclosure, all other embodiments obtained by a person of ordinary skill in the art without creative efforts fall within the protection scope of the present disclosure.

In the specification, claims, and accompanying drawings of the present disclosure, the terms “first”, “second”, “third”, “fourth”, and the like (if existent) are intended to distinguish between similar objects but are not necessarily intended to describe a specific order or sequence. It is to be understood that the data termed in such a way are interchangeable in proper circumstances, so that embodiments of the present disclosure described herein can be implemented in another order than the order illustrated or described herein. Moreover, the terms “include”, “have”, and any other variants mean to cover the non-exclusive inclusion, for example, a process, method, system, product, or device that includes a list of steps or units is not necessarily limited to those steps or units, but may include other steps or units not expressly listed or inherent to such a process, method, product, or device.

Embodiments of the present disclosure provide a method for generating an intersection area, electronic device, and storage medium, to efficiently generate an intersection area of an intersection node without relying on a complex pure geometric algorithm, and generate a more accurate intersection area with strong scalability.

An intersection area is an area in an electronic map that represents space where an intersection is located. Generating accurate intersection areas can not only provide a navigation engine with base map data at an intersection and enhance a visualization effect of a navigation interface, but also provide data support for autonomous driving during decision-making at the intersection, or provide data support for an object (such as a driver) that uses the electronic map to make driving decisions, to prevent a vehicle from driving beyond an intersection range, reduce a probability of accidents occurred at the intersection, and improve driving safety.

A method for generating an intersection area provided in the present disclosure relates to at least the following technologies, such as an intelligent transportation system, cloud computing, and a computer vision technology. For example, an intersection area of a target intersection node may be generated through road network data in the electronic map. In some embodiments, the intelligent transportation system may also be used to provide intelligent navigation route services for a driver and another driving object based on location information, contours, and the like of the intersection area. Alternatively, a terminal device may also use the computer vision technology to display a high-precision three-dimensional image corresponding to the intersection area in a navigation application page or a map page more truly and clearly.

In the related art, a pure geometric algorithm is usually relied on to calculate the intersection area based on a preset offset distance of each road. However, due to factors such as poor scalability of the pure geometric algorithm and mutual coupling of associated geometric conditions, there is a large deviation between the intersection area generated based on the pure geometric algorithm and an actual intersection area. In addition, existing intersection areas generated for lane-level navigation on the market are mainly based on high-precision map data. However, due to some restrictions, a coverage area of the high-precision map data is limited, and consequently, a corresponding intersection area cannot be generated in an area not covered by the high-precision map data.

To resolve the foregoing technical problems, embodiments of the present disclosure provide a method for generating an intersection area. The method does not need to rely on the pure geometric algorithm with poor scalability to generate an intersection area of an intersection node, and the intersection area generated based on the method provided in embodiments of the present disclosure has high accuracy and scalability. This is not only applicable to a high-precision map scenario, but also can obtain an effect similar to that brought by the high-precision map data for the area not covered by the high-precision map data.

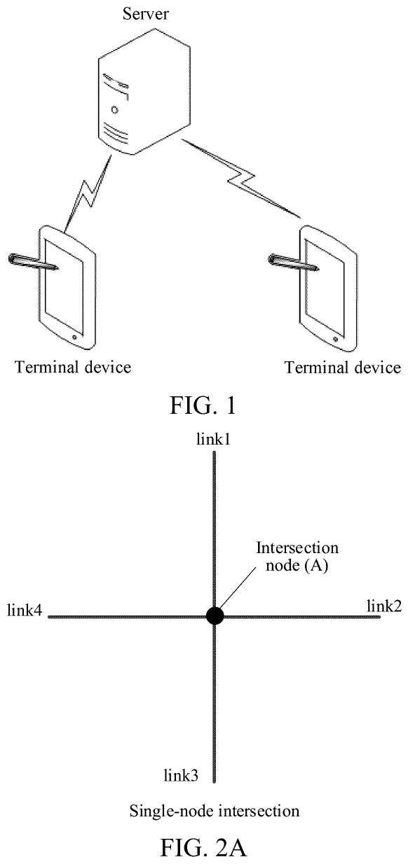

FIG. 1 is a schematic diagram of an application scenario of a method for generating an intersection area according to the present disclosure. As shown in FIG. 1, the application scenario includes a server. For example, the application scenario may further include a terminal device, and the like. The described server may be a back-end server of an application program, and the application program is also installed on the terminal device. The terminal device and the server may interact data with each other based on the application program. The server may store road network data such as road information of an intersection node and road surface width information corresponding to each road, and then use the road network data to generate an intersection area of the intersection node. For example, the server may send location information of the generated intersection area to the terminal device, so that the terminal device may display the intersection area based on the location information of the intersection area.

In actual application, the road network data such as road information of a target intersection node may also be stored in the terminal device, and the terminal device generates the intersection area based on the road network data. An execution entity of generating the intersection area is not limited in embodiments of the present disclosure. In the following embodiments of the present disclosure, description is made only by using an example in which the server is the execution entity.

In addition, the application program may be a map application, a navigation application, or any application program that supports display of a map page, such as a transportation application. The terminal device may be a vehicle-mounted terminal (such as a vehicle-mounted navigation terminal and a vehicle-mounted computer), a smartphone, a tablet computer, a notebook computer, a mobile internet device, a personal digital assistant (PDA), a desktop computer, a smart speaker, a smartwatch, or the like.

The server may be an independent physical server, or may be a server cluster or a distributed system including a plurality of physical servers, or may be a cloud server or a server cluster that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal device and the server may be connected directly or indirectly in a wired communication manner or a wireless communication manner. The present disclosure is not limited thereto. This may be specifically determined based on an actual application scenario, which is not limited herein.

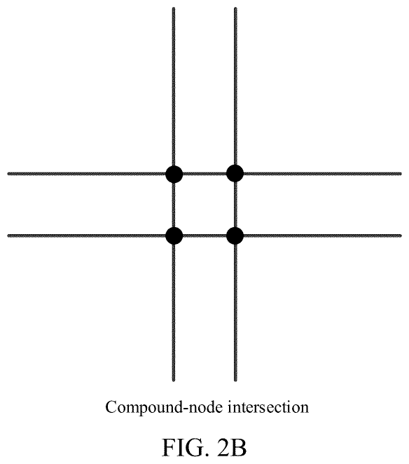

In addition, the intersection node described in FIG. 1 may be understood as an intersection where at least two roads intersect. An intersection may be understood as a location where at least two roads meet, and may generally be represented by several nodes. The intersection may be divided into a single-node intersection and a compound-node intersection based on quantity of nodes included. Based on this, the intersection node may include a single-node intersection and a compound-node intersection. For example, FIG. 2A shows a schematic diagram of a single-node intersection according to an embodiment of the present disclosure. As shown in FIG. 2A, in a scenario where the intersection node is a single-node intersection, four roads from link1 to link4 converge at the same intersection (that is, a dot A in FIG. 2A). In another example, FIG. 2B is a schematic diagram of a compound-node intersection according to an embodiment of the present disclosure. As shown in FIG. 2B, in a scenario where the intersection node is a compound-node intersection, the compound-node intersection may include four single-node intersections. For each single-node intersection, four roads converge at the same intersection. For details, refer to the context in FIG. 2A for understanding. Details are not described herein again.

For the intersection nodes shown in FIG. 2A and FIG. 2B, quantity of converged roads is 4, which is only an illustrative description. In actual application, 2, 3, 6, 10, or another quantity of roads may also be converged, which is not specifically limited in the present disclosure. In addition, the single-node intersection shown in FIG. 2A and the compound-node intersection shown in FIG. 2B only show a case in which links are perpendicular to each other. In actual application, there may also be a case in which links are not perpendicular to each other. This is not specifically limited in the present disclosure. In the following embodiments of the present disclosure, only an example in which links shown in FIG. 2A and FIG. 2B are mutually perpendicular to each other is used for description.

In addition, it can be learned from FIG. 2B that the compound-node intersection actually includes at least two single-node intersections. Therefore, in the subsequent description of the method for generating an intersection area provided in the present disclosure, only an example in which the single-node intersection shown in FIG. 2A is used as the target intersection node is used for detailed description. For a process of generating a corresponding intersection area for the composite-node intersection, reference may also be specifically made to a process of generating an intersection area of the single-node intersection. Details are not described again in embodiments of the present disclosure.

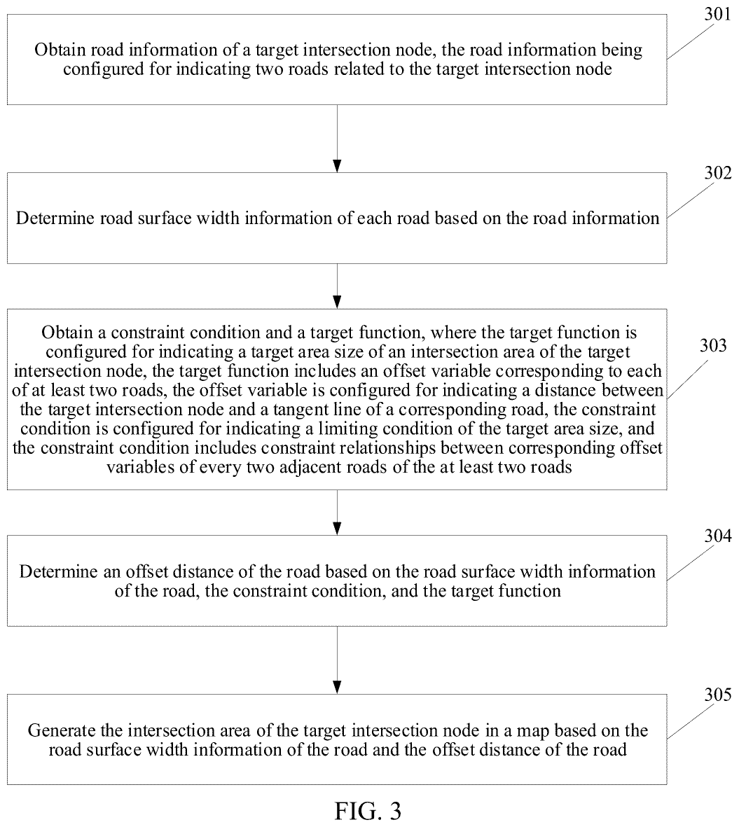

A scenario of the single-node intersection shown in FIG. 2A is used as an example. The following describes the method for generating an intersection area provided in embodiments of the present disclosure with reference to the accompanying drawings. FIG. 3 shows a flowchart of a method for generating an intersection area according to an embodiment of the present disclosure. The method may be performed by a computer device, such as the server or the terminal device in FIG. 1. As shown in FIG. 3, the method for generating an intersection area may include the following steps:

301. Obtain road information of a target intersection node, the road information being configured for indicating two roads related to the target intersection node.

In this example, the target intersection node may be the single-node intersection shown in FIG. 2A, or may be the compound-node intersection shown in FIG. 2B. Details are not described herein again. The following is described merely by using an example in which the target intersection node is the single-node intersection shown in FIG. 2A. For the target intersection node, corresponding road information may be obtained, and a quantity of roads that converge to the target intersection node may be obtained based on the road information. For example, the road information may indicate at least two roads that are jointly connected to the target intersection node. For example, for the single-node intersection shown in FIG. 2A, road information of the single-node intersection may indicate 4 links, and the 4 links are jointly connected to the same target intersection node A.

302. Determine road surface width information of each road based on the road information.

In this example, the road mentioned is generally represented by a line segment with no width in an ordinary navigation map. Before the intersection area of the target intersection node is generated, the line segment with no width needs to be widened into a road surface with a certain width. For example, the road surface width information of each road may be determined based on the road information, and the road surface width information may reflect a specific width of a road surface of the road. The road surface width information described may include but is not limited to the width of the road surface, and the like, which is not specifically limited in the present disclosure.

In some embodiments, for roads of different levels, corresponding road surfaces may be widened to have different widths. For example, in an urban road level, a road level of a trunk road is higher than that of a secondary trunk road, and the road level of the secondary trunk road is higher than that of a branch road. A higher road level indicates a wider road surface width of the corresponding road. For example, a road surface width of the trunk road is generally wider than that of the secondary trunk road, and the road surface width of the secondary trunk road is wider than that of the branch road. Based on this, a specific implementation process of determining the road surface width information of each road based on the road information in step 302 may be: determining a road level of each road based on the road information, and then determining the road surface width information of each road based on the road level of each road.

In addition, the road surface of each road includes a left side sub-road surface and a right side sub-road surface. Correspondingly, the road surface width information of the road may include width information of the left side sub-road surface and width information of the right side sub-road surface.

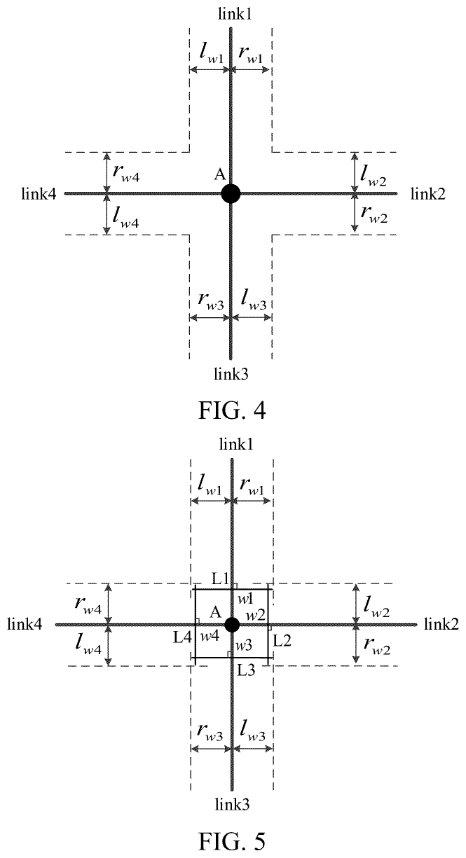

The single-node intersection shown in FIG. 2A is used as an example. FIG. 4 is a schematic diagram of a road after widening according to an embodiment of the present disclosure. As shown in FIG. 4, for the four roads (namely, link1 to link4) connected to the target intersection node A, each road may be widened into a road surface with a certain width. For example, for link1, corresponding road surface width information includes road surface width information of a left side sub-road surface of link1 (namely, l_{w1}) and road surface width information of a right side sub-road surface of link1 (namely, r_{w1}). For link2, corresponding road surface width information also includes road surface width information of a left side sub-road surface of link2 (namely, l_{w2}) and road surface width information of a right side sub-road surface of link2 (namely, r_{w2}). Similarly, for road surface width information of link3 and road surface width information of link4, reference may also be made to the road surface width information of link1 and link2. Details are not described herein again.

The road described above may include but are not limited to the trunk road, the secondary trunk road, the branch road, and the like. In actual application, the road may also include an expressway, a neighborhood road, and the like, which is not specifically limited in the embodiments of the present disclosure. In addition, for the road surface width information such as l_{w1}, r_{w1}, l_{w2}, r_{w2} shown in FIG. 4, values thereof may be the same or different. This is not specifically limited in the present disclosure.

303. Obtain a constraint condition and a target function, where the target function is configured for indicating a target area size of an intersection area of the target intersection node, the target function includes an offset variable corresponding to each of at least two roads, the offset variable is configured for indicating a distance between the target intersection node and a tangent line of a corresponding road, the constraint condition is configured for indicating a limiting condition of the target area size, and the constraint condition includes constraint relationships between corresponding offset variables of every two adjacent roads of the at least two roads.

In this example, for the every two adjacent roads, if corresponding tangent lines of the two roads intersect, the generated intersection area of the target intersection node has an abnormal shape and cannot accurately reflect a real intersection area. Therefore, to ensure that there is no abnormality in the shape of the intersection area, it is necessary to ensure that the corresponding tangent lines of the every two adjacent roads do not intersect. Each road is perpendicular to a corresponding tangent line thereof, and a position of the tangent line may be represented by a distance from an intersection of the tangent line and the road to the target intersection node. It is to be understood that the intersection of the tangent lines mentioned in this embodiment of the present disclosure means that intersection occurs at a middle portion of the tangent lines, which does not include a case of intersecting at an endpoint of the two tangent lines.

In this embodiment of the present disclosure, the distance from the intersection of the tangent line and the road to the target intersection node is referred to as an offset distance. Whether the corresponding tangent lines of the every two adjacent roads intersect depends on offset distances of the two roads. For example, when the offset distance of the road is too small, the corresponding tangent lines intersect at the middle portion of the tangent lines, resulting in an abnormal shape of the intersection area.

For example, FIG. 5 is a schematic diagram in which tangent lines of a road intersect according to an embodiment of the present disclosure. As shown in FIG. 5, a tangent line of link1 (namely, L1) intersects a tangent line of link2 (namely, L2), and L1 and L2 intersect because a value of an offset variable of link1 (namely, w1) and a value of an offset variable of adjacent link2 (namely, w2) are too small. Similarly, L2 intersects a tangent line of link3 (namely, L3). This is also because the value of w2 and a value of an offset variable of adjacent link3 (namely, w3) are too small. For an intersection of L3 and a tangent of link4 (namely, L4) and an intersection of L4 and L1, reference may also be made to the intersection of L1 and L2 or the intersection of L2 and L3 for understanding. Details are not described herein again.

It is to be understood that an intersection of tangent lines of the road shown in FIG. 5 is merely described by using the intersection of all four links as an example. In actual application, only two or three of the four links may intersect, which is not specifically limited in the present disclosure. In addition, the offset variable mentioned may be configured for indicating the distance between the target intersection node and the tangent line of the corresponding road. For example, w1 may be configured for indicating a distance between the target intersection node A and the tangent line L1 of link1. After a specific value is assigned to the offset variable, it may be referred to as an offset distance.

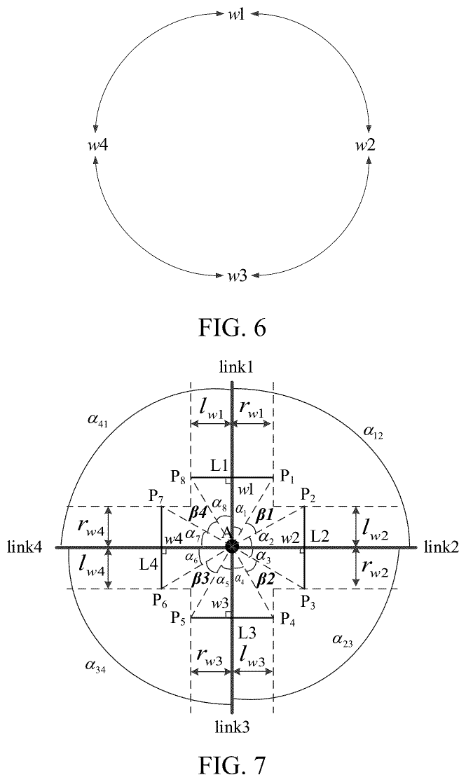

Based on this, a value of w1 affects a value of adjacent w2, the value of w2 affects a value of adjacent w3, the value of w3 affects a value of adjacent w4, and the value of w4 affects the value of adjacent w1. Similarly, the value of w1 affects the value of adjacent w4, the value of w4 affects the value of adjacent w3, the value of w3 affects the value of adjacent w2, and the value of w2 affects the value of adjacent w1. It is clear that, regardless of whether the four links of the target intersection node are sorted in a clockwise order or in an anticlockwise order, a coupling relationship between the offset variables w1, w2, w3, and w4 is circular. For details, reference may be made to the schematic diagram of the relationship between the offset distances shown in FIG. 6 for understanding. This coupling relationship is difficult to deal with by using the pure geometric algorithm in the existing solution. Therefore, in embodiments of the present disclosure, a mathematical optimization method is used to deal with this coupling relationship, that is, the constraint relationship between the offset variables of each road is changed into a constraint equation of an optimization problem.

As described above, the tangent line of each road is to meet the following two conditions: (1) The tangent line is perpendicular to the road (for example: L1 is perpendicular to the link). (2) The tangent lines do not intersect with each other, or only intersect at a tangent endpoint. Based on this, the constraint equation that the offset variable is to meet is established by using the scenario shown in FIG. 4 as an example. For details, reference may be made to the schematic diagram in FIG. 7 in which the tangent lines do not intersect or intersect at the endpoints of the tangent lines for understanding.

As shown in FIG. 7, when a value of the offset variable w of each road enable the tangent line L of the corresponding roads not to intersect or only intersect at the endpoints, in this case, the constraint condition may be constructed based on the constraint relationship between the offset variables of the every two adjacent roads.

The constraint relationship between the offset variables of the every two adjacent roads may be constructed through included angle information between the every two adjacent roads. For example, the included angle information between the every two adjacent roads may be determined based on road surface width information and corresponding offset variables of the every two adjacent roads, and the constraint condition is constructed based on the included angle information between the every two adjacent roads. The mentioned included angle information is configured for indicating an intersection status between the corresponding tangent lines of two adjacent roads. For details of the intersection status between the tangent lines described, reference may be made to the context shown in FIG. 5 for understanding, which are not described herein again.

In addition, the constraint conditions may be constructed as follows: An included angle between a first road and a second road is obtained, where the first road and the second road are adjacent roads among the at least two roads related to the target intersection node; and obtaining a first included angle between the first road and a boundary line of a right side sub-road surface of the first road, a second included angle between the second road and a boundary line of a left side sub-road surface of the second road, and a third included angle between the boundary line of the right side sub-road surface of the first road and the boundary line of the left side sub-road surface of the second road. Then, the constraint condition is constructed based on the included angle between the first road and the second road, the first included angle, the second included angle, and the third included angle.

For example, coordinates of a road shape point of the first road and coordinates of a road shape point of the second road are firstly obtained. Then, the included angle between the first road and the second road is calculated based on the coordinates of the road shape point of the first road and the coordinates of the road shape point of the second road. On the premise that a road form of the first road and a road form of the second road are fixed, the included angle between the roads calculated based on the coordinates of the road shape point of the road is also fixed, that is, the included angle between the first road and the second road obtained is a specific value.

In addition, the first included angle may also be represented by the road surface width information of the right side sub-road surface of the first road and the offset variable of the first road. Similarly, the second included angle may also be represented by the road surface width information of the left side sub-road surface of the second road and the offset variable of the second road. The first included angle and the second included angle described are functions related to the offset variable w of the corresponding road.

For details of the left side sub-road surface and the right side sub-road surface described, reference may be made to the context described in FIG. 4 for understanding, which are not described herein again.

A sum of the foregoing first included angle, second included angle, and third included angle is less than or equal to the included angle between the first road and the second road.

For example, a schematic diagram in an upper right corner shown in FIG. 7 is used as an example, link1 in FIG. 7 may be understood as the first road, link2 may be understood as the second road, and link1 is adjacent to link2. In addition, a point A may be understood as the target intersection node. An intersection point of the tangent line L1 and the boundary line of the right side sub-road surface of link1 is P1, and an intersection point of the tangent line L2 and the boundary line of the left side sub-road surface of link2 is P2.

The point A is used as an origin, and an included angle between link1 and link2, that is, α₁₂, may be obtained by calculating coordinates of the road shape point of link1 and coordinates of the road shape point of link2.

Similarly, the point A is used as an origin, and the first included angle, that is, α₁, may be obtained by calculating an angle between link1 and PIA. For example, because the tangent line L1 is perpendicular to link1, and the road surface width of the right side sub-road surface of link1 is r_{w1}, the road surface width of the right side sub-road surface of link1 r_{w1} and the offset variable w1 of link1 may be processed through an inverse tangent function, which is obtained as follows:

$${α}_{1} = arctan \frac{{r}_{w 1}}{w 1}$$

The second included angle may be obtained by calculating an angle between link2 and P₂A, that is, α₂. For example, because the tangent line L2 is perpendicular to link2, and the road surface width of the left side sub-road surface of link2 is l_{w2}, the road surface width of the left side sub-road surface of link2 l_{w2} and the offset variable w2 of link2 may also be processed through an inverse tangent function, which is further obtained as follows:

$${α}_{2} = arctan \frac{{l}_{w 2}}{w 2}$$

To ensure that L1 and L2 do not intersect or only intersect at the endpoints, an included angle α₁ and an included angle α₂ are to meet:

$${α}_{1} + {α}_{2} + min {β}_{1} \leq {α}_{12}$$

That is,

$${α}_{1} + {α}_{2} + min {β}_{1} = arctan \frac{{r}_{w 1}}{w 1} + arctan \frac{{l}_{w 2}}{w 2} + min {β}_{1} \leq {α}_{12}$$

minβ1 is a minimum value of an included angle P₁AP₂, that is, the included angle between the boundary line of the right side sub-road surface of link1 and the boundary line of the left side sub-road surface of link2. In addition, β₁≥0.

Generally, there are n (n>1) roads associated with the target intersection node, and n constraint conditions may be constructed. For example, the target intersection node A shown in FIG. 7 is associated with four roads, and in this case, four constraint conditions may be constructed for the target intersection node A, which are respectively as follows:

$${α}_{1} + {α}_{2} + min {β}_{1} = arctan \frac{{r}_{w 1}}{w 1} + arctan \frac{{l}_{w 2}}{w 2} + min {β}_{1} \leq {α}_{12} \qquad ( 1 )$$

$${α}_{3} + {α}_{4} + min {β}_{2} = arctan \frac{{r}_{w 2}}{w 2} + arctan \frac{{l}_{w 3}}{w 3} + min {β}_{2} \leq {α}_{23} \qquad ( 2 )$$

$${α}_{5} + {α}_{6} + min {β}_{3} = arctan \frac{{r}_{w 3}}{w 3} + arctan \frac{{l}_{w 4}}{w 4} + min {β}_{3} \leq {α}_{34} \qquad ( 3 )$$

$${α}_{7} + {α}_{8} + min {β}_{4} = arctan \frac{{r}_{w 4}}{w 4} + arctan \frac{{l}_{w 1}}{w 1} + min {β}_{4} \leq {α}_{41} \qquad ( 4 )$$

The foregoing constraint condition (2) is constructed based on the included angle information between link2 and link3, where α₃ is the included angle between link2 and P₃A, α₄ is the included angle between link3 and P₄A, and β₂ is the included angle between P₃A and P₄A. The foregoing constraint condition (3) is constructed based on the included angle information between link3 and link4, where α₅ is the included angle between link3 and P₅A, α₆ is the included angle between link4 and P₆A, and β₃ is the included angle between PsA and P₆A. The foregoing constraint condition (4) is constructed based on the included angle information between link4 and link1, where α₇ is the included angle between link4 and P₇A, α₈ is the included angle between link1 and P₈A, and β₄ is the included angle between P₇A and P₈A. For details, reference may be made to the constraint condition constructed between link1 and link2 in FIG. 7 for understanding, which are not described herein again.

In addition, on the premise that the constraint condition described above is met, it is expected that the intersection area of the generated target intersection node is as small as possible. In this case, the target area size of the intersection area of the target intersection node may be used as the target function, and the target area size may be limited by the constraint condition constructed above. The target function includes an offset variable corresponding to each of at least two roads. For the constraint relationship between each offset variable, reference may be made to the constraint condition constructed above for understanding. Details are not described herein again. In other words, the target area size of the intersection area is affected by the value of the offset variable of the road associated with the target intersection node. Therefore, representation of the target area size of the intersection area of the target intersection node may be determined based on the value of the offset variable w of the road associated with the target intersection node. For example, for the target intersection node A in FIG. 7, when a sum of squares of the offset variables w is used as the representation of the target area size of the intersection area, the target area size of the intersection area may be represented as follows: V=w1²+w2²+w3²+w4², where w1, w2, w3, and w4 are corresponding offset variables of link1, link2, link3, and link4.

In addition to using the sum of the squares of the offset variables to represent the target area size of the intersection area, in practical application, it may also be expressed through a sum of cubes of the offset variables, a sum of N^{th} (N≥2) powers, a sum of absolute values, and the like. This is not specifically limited in this embodiment of the present disclosure.

In this way, the target function about the target area size of the intersection area may be constructed, that is, min V=w1²+w2²+w3²+w4².

304. Determine an offset distance of the road based on the road surface width information of the road, the constraint condition, and the target function.

In this example, after the constraint condition is constructed and the target function is obtained through the operation of step 303, the target function may be solved and calculated based on the road surface width information and the constraint condition of the road, and then a specific value of each offset variable in the target function is calculated, that is, the offset distance of each road is obtained. For example, after the constraint condition and the target function are constructed, an optimization mathematical model corresponding to the target intersection node in FIG. 7 in the present disclosure may be constructed as follows:

$$min V = w {1}^{2} + w {2}^{2} + w {3}^{2} + w {4}^{2}$$

$$s . t .$$

$${α}_{1} + {α}_{2} + min {β}_{1} = arctan \frac{{r}_{w 1}}{w 1} + arctan \frac{{l}_{w 2}}{w 2} + min {β}_{1} \leq {α}_{12}$$

$${α}_{3} + {α}_{4} + min {β}_{2} = arctan \frac{{r}_{w 2}}{w 2} + arctan \frac{{l}_{w 3}}{w 3} + min {β}_{2} \leq {α}_{23}$$

$${α}_{5} + {α}_{6} + min {β}_{3} = arctan \frac{{r}_{w 3}}{w 3} + arctan \frac{{l}_{w 4}}{w 4} + min {β}_{3} \leq {α}_{34}$$

$${α}_{7} + {α}_{8} + min {β}_{4} = arctan \frac{{r}_{w 4}}{w 4} + arctan \frac{{l}_{w 1}}{w 1} + min {β}_{4} \leq {α}_{41}$$

$$w 1 > 0$$

$$w 2 > 0$$

$$w 3 > 0$$

$$w 4 > 0$$

In this way, under the constraint condition and the road surface width information of the road, the target function may be solved based on a preset constraint optimization model such as an interior point method. For example, after the road surface width information of each road (including the road surface width information of the left side sub-road surface and the road surface width information of the right side sub-road surface) is obtained, the road surface width information of each road may be processed through the preset constraint optimization model, and then a specific value of the offset variable of each road is obtained, that is, an optimal solution of the offset distance of each road is obtained.

305. Generate the intersection area of the target intersection node in a map based on the road surface width information and the offset distance of the road.

In this example, after the offset distance of each road through calculation is obtained, the intersection area of the target intersection node in a map can be generated based on the road surface width information of each road and the corresponding offset distance. For example, the position of the intersection shape point may be determined based on the road surface width information of each road and the corresponding offset distance of each road. In this way, after the position of the intersection shape point is obtained, the intersection area of the target intersection node may be generated based on the position of the intersection shape point. The intersection shape point described may indicate a regional contour feature of the intersection area. For example, eight intersection shape points P₁ to P₈ in FIG. 7 may accurately describe the regional contour of the intersection area.

For example, the position of each intersection shape point may also be determined in the following manners: calculating the coordinates of the first intersection shape point based on the road surface width information of the right side sub-road surface of the first road and the offset distance of the first road, the first intersection shape point is the intersection point between the tangent line of the first road and the boundary line of the right side sub-road surface of the first road, and the coordinates of the first intersection shape point is configured for indicating the position of the first intersection shape point; and calculating the coordinates of the second intersection shape point based on the road surface width information of the left side sub-road surface of the second road and the offset distance of the second road, where the second intersection shape point is the intersection point between the tangent line of the second road and the boundary line of the left side sub-road surface of the second road, and the coordinates of the second intersection shape point are configured for indicating the position of the second intersection shape point. Then, the intersection area of the target intersection node may be generated by connecting the coordinates of the first intersection shape point and the coordinates of the second intersection shape point.

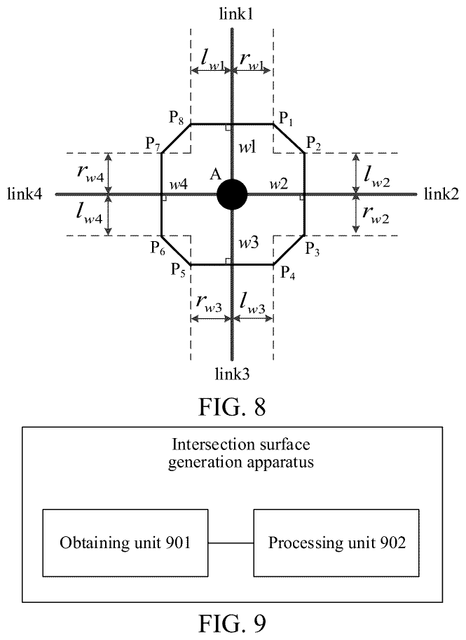

For example, an example in which P₁ in FIG. 8 is the first intersection shape point and P₂ in FIG. 8 is the second intersection shape point is used, the road surface width information of the right side sub-road surface of link1, that is, r_{w1}, is calculated above, and the specific value of the offset variable w1 of link1 is calculated in step 304. In this case, the target intersection node A needs to be used as an origin, and the coordinates of P1 may be calculated based on the Pythagorean theorem. Similarly, the road width information of the left side sub-road surface of link2 is calculated above, that is l_{w2}, and the specific value of the offset variable w2 of link2 is calculated in step 304. In this case, the target intersection node A needs to be used as the origin, and the coordinates of P2 point may be calculated through the Pythagorean theorem.

Based on the same principle, the coordinates of remaining intersection shape points (namely, P₃ to P₈) may be obtained through solving, and the intersection shape points are connected by using straight lines to obtain the intersection area. For details, reference may be made to the schematic diagram of the intersection area shown in FIG. 8 for understanding.

In some embodiments, after the intersection area is generated, the intersection area may also be displayed through a terminal device.

In embodiments of the present disclosure, the road information of the target intersection node is obtained, and the road surface width information of each road is determined based on the road information, and the constraint condition and the target function are obtained. The target function is configured for indicating the target area size of the intersection area of the target intersection node. The constraint condition includes the constraint relationship between the corresponding offset variables of every two adjacent roads in the at least two roads and is configured for indicating the limiting condition of the target area size. The target function includes at least two offset variables. In this way, the offset distance of each road may be calculated based on the road surface width information of the road, the constraint condition, and the target function. Further, the intersection area of the target intersection node may be generated in the map based on the road surface width information of the road and the offset distance of the road. Through the foregoing manner, it is only necessary to construct the constraint condition based on the constraint relationship between the offset variables of adjacent roads, and calculate the offset distance of the road based on the road surface width information of the road, to generate the intersection area of the intersection node efficiently and accurately without relying on the complex pure geometric algorithm. In some scenarios with complex roads, a corresponding accurate offset distance may be calculated by modifying the constraint condition, which is highly scalable and may be widely used in various map scenarios to generate the intersection area efficiently and accurately in various map scenarios.

The solutions provided in embodiments of the present disclosure are mainly described above from a perspective of a method. It may be understood that, to implement the foregoing functions, a corresponding hardware structure/or a corresponding software module for performing each function is included. A person skilled in the art is to be easily aware that, in combination with the examples described in the embodiments disclosed in this present application, modules and algorithm steps can be implemented in the present disclosure in a form of hardware or a combination of hardware and computer software. Whether a function is performed through hardware or hardware driven by computer software depends on particular applications and design constraint conditions of the technical solutions. A person skilled in the art may use different methods to implement the described functions for each particular application, but it is to not be considered that the implementation goes beyond the scope of the present disclosure.

In embodiments of the present disclosure, the apparatus may be divided into functional modules based on the foregoing method examples. For example, the apparatus may be division functional modules corresponding to functions, or two or more functions may be integrated into one processing module. The foregoing integrated module may be implemented in a form of hardware, or may be implemented in a form of a software functional module. In embodiments of the present disclosure, division into modules is an example and is merely logical function division, and may be other division in actual implementation.

The following describes intersection area generation apparatus provided in embodiments of the present disclosure in detail. FIG. 9 is a schematic diagram of an embodiment of an intersection area generation apparatus according to an embodiment of the present disclosure. As shown in FIG. 9, the intersection area generation apparatus may include an obtaining unit 901 and a processing unit 902.

The obtaining unit 901 is configured to obtain road information of a target intersection node, where the road information is configured for indicating at least two roads related to the target intersection node.

The processing unit 902 is configured to determine road surface width information of each road based on the road information.

The obtaining unit 901 is further configured to obtain a constraint condition and a target function. The target function is configured for indicating a target area size of an intersection area of the target intersection node, the target function includes an offset variable corresponding to each of the at least two roads. The offset variable is configured for indicating a distance between the target intersection node and a tangent line of a corresponding road. The constraint condition is configured for indicating a limiting condition of the target area size. The constraint condition includes constraint relationships between corresponding offset variables of every two adjacent roads in the at least two roads.

The processing unit 902 is further configured to determine an offset distance of the road based on the road surface width information of the road, the constraint condition, and the target function, and generate the intersection area of the target intersection node in a map based on the road surface width information of the road and the offset distance of the road.

In some embodiments, the processing unit 902 is configured to determine included angle information between every two adjacent roads based on the road surface width information of the every two adjacent roads and an offset variable of the road. The included angle information is configured for indicating an intersection status between corresponding tangent lines of two adjacent roads and construct the constraint condition based on the included angle information between the every two adjacent roads.

In some embodiments, the road surface of each road includes a left side sub-road surface and a right side sub-road surface. The obtaining unit 901 is further configured to obtain an included angle between a first road and a second road, where the first road and the second road are adjacent roads among the at least two roads; and obtain a first included angle between the first road and a boundary line of a right side sub-road surface of the first road, a second included angle between the second road and a boundary line of a left side sub-road surface of the second road, and a third included angle between the boundary line of the right side sub-road surface of the first road and the boundary line of the left side sub-road surface of the second road.

The processing unit 902 is specifically configured to construct the constraint condition based on the included angle between the first road and the second road, the first included angle, the second included angle, and the third included angle.

In some other embodiments, a sum of the first included angle, the second included angle, and third included angle is less than or equal to the included angle between the first road and the second road.

In some other embodiments, the obtaining unit 901 is specifically configured to obtain coordinates of a road shape point of the first road and coordinates of a road shape point of the second road. The processing unit 902 is specifically configured to calculate the included angle between the first road and the second road based on the coordinates of the road shape point of the first road and the coordinates of the road shape point of the second road.

In some other embodiments, the first included angle may also be represented by the road surface width information of the right side sub-road surface of the first road and the offset variable of the first road.

In some other embodiments, the second included angle may also be represented by the road surface width information of the left side sub-road surface of the second road and the offset variable of the second road.

In some other embodiments, the processing unit 902 is specifically configured to determine a road level of each road based on the road information; and determine the road surface width information of each road based on the road level of each road.

In some other embodiments, the processing unit 902 is specifically configured to determine a position of an intersection shape point based on the road surface width information and the offset distance of the road, where the intersection shape point is configured for indicating a road regional contour feature of the intersection area; and generate the intersection area of the target intersection node in the map based on the position of the intersection shape point.

In some other embodiments, the road surface width information of the road includes road surface width information of the left side sub-road surface of the road and road surface width information of the right side sub-road surface of the road. The processing unit 902 is specifically configured to calculate coordinates of a first intersection shape point based on the road surface width information of the right side sub-road surface of the first road and an offset distance of the first road, where the first intersection shape point is an intersection point between a tangent line of the first road and the boundary line of the right side sub-road surface of the first road; calculate coordinates of a second intersection shape point based on the road surface width information of the left side sub-road surface of the second road and an offset distance of the second road, where the second intersection shape point is an intersection point between a tangent line of the second road and the boundary line of the left side sub-road surface of the second road, and the first road and the second road are adjacent roads among the at least two roads; and connect the coordinates of the first intersection shape point and the coordinates of the second intersection shape point, to generate the intersection area of the target intersection node.

In some other embodiments, the processing unit 902 is specifically configured to determine the offset distance of the road based on a preset constraint optimization model and the target function when the constraint condition and the road surface width information of the road are known.

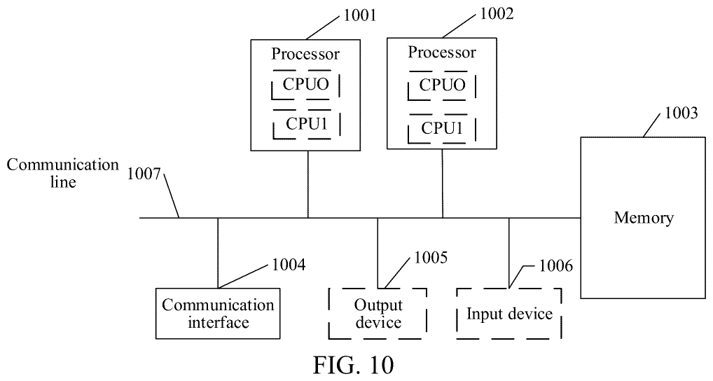

The intersection area generation apparatus in this embodiment of the present invention is described above from a perspective of a modular functional entity. The following describes a computer device configured to perform the intersection area generation method in embodiments of the present disclosure from a perspective of hardware processing. FIG. 10 is a schematic diagram of a hardware structure of a computer device according to an embodiment of the present disclosure. The intersection area generation apparatus may vary greatly due to different configurations or performance. The intersection area generation apparatus may include at least one processor 1001, a communication line 1007, a memory 1003, and at least one communication interface 1004.

The processor 1001 may be a general-purpose central processing unit (CPU), a microprocessor, an application-specific integrated circuit (which is a server IC), or one or more integrated circuits configured to control execution of programs in solutions of the present disclosure.

The communication line 1007 may include a path for transmitting information between the foregoing components.

The communication interface 1004 uses any apparatus such as a transceiver, and is configured to communicate with another apparatus or a communication network, for example, the Ethernet, a radio access network (RAN), or a wireless local area network (WLAN).

The memory 1003 may be a read-only memory (ROM) or another type of static storage apparatus that may store information and instructions, a random access memory (RAM) or another type of dynamic storage apparatus that may store information and instructions. The memory may be independent and connected to the processor through the communication line 1007. The memory may be integrated into the processor.

The memory 1003 is configured to store computer-executable instructions for executing the solutions of the present disclosure, and the processor 1001 controls the execution. The processor 1001 is configured to execute the computer-executable instructions stored in the memory 1003, to implement the method for generating an intersection area provided in the foregoing embodiments of the present disclosure.

In some embodiments, the computer-executable instructions in embodiments of the present disclosure may also be referred to as application program code, which is not specifically limited in embodiments of the present disclosure.

In a specific implementation, in an embodiment, the computer device may include a plurality of processors, for example, the processor 1001 and a processor 1002 shown in FIG. 10. Each of these processors may be a single core central processing unit (single-CPU), or may be a multi-core central processing unit (multi-CPU). The processor herein may be one or more apparatuses, circuits, and/or processing cores configured to process data (such as computer program instructions).

In a specific implementation, in an embodiment, the computer device may further include an output device 1005 and an input device 1006. The output device 1005 communicates with the processor 1001, and may display information in a plurality of manners. The input device 1006 communicates with the processor 1001, and may receive input from a target object in a plurality of manners. For example, the input device 1006 may be a mouse, a touchscreen apparatus, a sensing apparatus, and the like.

The foregoing computer device may be a general-purpose apparatus or a dedicated apparatus. In a specific implementation, the computer device may be a server, a terminal, or the like, or an apparatus having a structure similar to that in FIG. 10. A type of the computer device is not limited in embodiments of the present disclosure.

The processor 1001 in FIG. 10 may invoke the computer-executable instructions stored in the memory 1003, so that the computer device performs the method corresponding to the method embodiment in FIG. 3.

Specifically, functions/implementation processes of the processing unit 902 in FIG. 9 may be implemented by the processor 1001 in FIG. 10 by invoking the computer-executable instructions stored in the memory 1003. Functions/implementation processes of the obtaining unit 901 in FIG. 9 may be implemented by using the communication interface 1004 in FIG. 10.

The embodiments of the present disclosure have the following advantages. For example, the road information of the target intersection node is obtained, the road surface width information of each road related to the target intersection node is determined based on the road information, and the constraint condition and the target function are obtained, the target function being configured for indicating the target area size of the intersection area of the target intersection node, the constraint condition including the constraint relationship between the corresponding offset variables of every two adjacent roads in the at least two roads and being configured for indicating the limiting condition of the target area size, and the target function including an offset variable corresponding to each of the at least two roads related to the target intersection node. In this way, an offset distance of each road may be calculated based on the road surface width information of the road, the constraint condition, and the target function. Further, the intersection area of the target intersection node may be generated in the map based on the road surface width information of the road and the offset distance of the road. Through the foregoing manner, it is only necessary to construct the constraint condition based on the constraint relationship between the offset variables of adjacent roads, and calculate the offset distance of the road based on the road surface width information of the road, to generate the intersection area of the intersection node efficiently and accurately without relying on the complex pure geometric algorithm. In some scenarios with complex roads, a corresponding accurate offset distance may be calculated by modifying the constraint condition, which is highly scalable and may be widely used in various map scenarios to generate the intersection area efficiently and accurately in various map scenarios.

All or a part of the foregoing embodiments may be implemented through software, hardware, firmware, or any combination thereof. When software is used to implement the embodiments, all or a part of the embodiments may be implemented in a form of a computer program product.

It may be clearly understood by a person skilled in the art that for convenient and brief description, for a detailed working process of the foregoing system, apparatus, and unit, refer to a corresponding process in the foregoing method embodiments, and details are not described herein again.

In the several embodiments provided in the present disclosure, it may be understood that the disclosed system, apparatus, and method may be implemented in other manners. For example, the described apparatus embodiments are merely examples. For example, division into the units is merely logical function division. In actual implementation, there may be another division manner. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electrical, mechanical, or another form.

The units described as separate parts may or may not be physically separate. Parts displayed as units may or may not be physical units, to be specific, may be located in one position, or may be distributed on a plurality of network units. Some or all of the units may be selected based on actual requirements to achieve the objectives of the solutions of embodiments.

In addition, functional units in embodiments of the present disclosure may be integrated into one processing unit, each of the units may exist alone physically, or two or more units are integrated into one unit. The integrated unit may be implemented in a form of hardware, or may be implemented in a form of a software function unit.

When the integrated unit is implemented in the form of a software functional unit and sold or used as an independent product, the integrated unit may be stored in a computer-readable storage medium. Based on such an understanding, the technical solutions of the present disclosure essentially, or a part contributing to the related art, or all or some of the technical solutions may be implemented in a form of a software product. The computer software product is stored in a storage medium and includes a plurality of instructions for instructing a computer device (which may be a personal computer, a server, a network device, or the like) to perform all or some of the steps of the methods in embodiments of the present disclosure. The foregoing storage medium includes any medium that may store program code, such as a USB flash drive, a removable hard disk, a read-only memory (ROM), a random access memory (RAM), a magnetic disk, or an optical disc.

All or a part of the foregoing embodiments may be implemented by software, hardware, firmware, or any combination thereof. When software is used to implement embodiments, all or a part of embodiments may be implemented in a form of a computer program product.

The computer program product includes one or more computer instructions. When the computer-executable instructions are loaded and executed on a computer, the procedures, or functions based on embodiments of the present disclosure are all or partially generated. The computer may be a general-purpose computer, a special-purpose computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like.

The foregoing embodiments are merely intended to describe the technical solutions of the present disclosure, but not intended to limit the present disclosure. Although the present disclosure is described in detail with reference to the foregoing embodiments, a person of ordinary skill in the art is to understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A method for generating an intersection area, performed by a computer device, comprising:
obtaining road information of a target intersection node, the road information being configured for indicating at least two roads related to the target intersection node;
determining road surface width information of roads based on the road information;
obtaining a constraint condition and a target function, the target function being configured for indicating a target area size of an intersection area of the target intersection node, the target function comprising an offset variable corresponding to a road of the at least two roads, the offset variable being configured for indicating a distance between the target intersection node and a tangent line of a corresponding road, the constraint condition being configured for indicating a limiting condition of the target area size, and the constraint condition comprising constraint relationships between corresponding offset variables of every two adjacent roads of the at least two roads;
determining an offset distance of the road based on the road surface width information of the road, the constraint condition, and the target function; and
generating the intersection area of the target intersection node in a map based on the road surface width information of the road and the offset distance of the road.

2. The method according to claim 1, wherein obtaining the constraint condition comprises:
determining included angle information between the every two adjacent roads based on road surface width information and corresponding offset variables of the every two adjacent roads, and the included angle information being configured for indicating an intersection status between corresponding tangent lines of the every two adjacent roads; and
constructing the constraint condition based on the included angle information between the every two adjacent roads.

3. The method according to claim 2, wherein a road surface of the road comprises a left side sub-road surface and a right side sub-road surface, and constructing the constraint condition based on the included angle information between the every two adjacent roads comprises:
obtaining an included angle between a first road and a second road, wherein the first road and the second road are adjacent roads among the at least two roads;
obtaining a first included angle between the first road and a boundary line of a right side sub-road surface of the first road, obtaining a second included angle between the second road and a boundary line of a left side sub-road surface of the second road, and obtaining a third included angle between the boundary line of the right side sub-road surface of the first road and the boundary line of the left side sub-road surface of the second road; and
constructing the constraint condition based on the included angle between the first road and the second road, the first included angle, the second included angle, and the third included angle.

4. The method according to claim 3, wherein a sum of the first included angle, the second included angle, and the third included angle is less than or equal to the included angle between the first road and the second road.

5. The method according to claim 3, wherein obtaining the included angle between the first road and the second road comprises:
obtaining coordinates of a road shape point of the first road and coordinates of a road shape point of the second road; and
calculating the included angle between the first road and the second road based on the coordinates of the road shape point of the first road and the coordinates of the road shape point of the second road.

6. The method according to claim 3, wherein the first included angle is represented by road surface width information of the right side sub-road surface of the first road and an offset variable of the first road.

7. The method according to claim 3, wherein the second included angle is represented by road surface width information of the left side sub-road surface of the second road and an offset variable of the second road.

8. The method according to claim 1, wherein determining the road surface width information of a road based on the road information comprises:
determining a road level of the road based on the road information; and
determining the road surface width information of the road based on the road level of the road.

9. The method according to claim 1, wherein generating the intersection area of the target intersection node in the map based on the road surface width information of the road and the offset distance of the road comprises:
determining a position of an intersection shape point based on the road surface width information and a corresponding offset distance of a road, the intersection shape point being configured for indicating a regional contour feature of the intersection area; and
generating the intersection area of the target intersection node in the map based on the position of the intersection shape point.

10. The method according to claim 9, wherein the road surface width information of the road comprises road surface width information of the left side sub-road surface of the road and road surface width information of the right side sub-road surface of the road; determining the position of an intersection shape point based on the road surface width information and a corresponding offset distance of a road comprises:
calculating coordinates of a first intersection shape point based on the road surface width information of the right side sub-road surface of the first road and an offset distance of the first road, the first intersection shape point being an intersection point between a tangent line of the first road and the boundary line of the right side sub-road surface of the first road; and
calculating coordinates of a second intersection shape point based on the road surface width information of the left side sub-road surface of the second road and an offset distance of the second road, the second intersection shape point being an intersection point between a tangent line of the second road and the boundary line of the left side sub-road surface of the second road; and the first road and the second road being adjacent roads among the at least two roads; and
generating the intersection area of the target intersection node based on the position of the intersection shape point comprises:
connecting the coordinates of the first intersection shape point and the coordinates of the second intersection shape point to generate the intersection area of the target intersection node.

11. The method according to claim 1, wherein determining the offset distance of the road based on the road surface width information of the road, the constraint condition, and the target function comprises:
determining the offset distance of the road based on a preset constraint optimization model and the target function when the constraint condition and the road surface width information of the road are known.

12. A computer device, comprising one or more processors and a memory containing program instructions that, when being executed, causes the one or more processors to perform:
obtaining road information of a target intersection node, the road information being configured for indicating at least two roads related to the target intersection node;
determining road surface width information of roads based on the road information;
obtaining a constraint condition and a target function, the target function being configured for indicating a target area size of an intersection area of the target intersection node, the target function comprising an offset variable corresponding to a road of the at least two roads, the offset variable being configured for indicating a distance between the target intersection node and a tangent line of a corresponding road, the constraint condition being configured for indicating a limiting condition of the target area size, and the constraint condition comprising constraint relationships between corresponding offset variables of every two adjacent roads of the at least two roads;
determining an offset distance of the road based on the road surface width information of the road, the constraint condition, and the target function; and
generating the intersection area of the target intersection node in a map based on the road surface width information of the road and the offset distance of the road.

13. The device according to claim 12, wherein the one or more processors are further configured to perform:
determining included angle information between the every two adjacent roads based on road surface width information and corresponding offset variables of the every two adjacent roads, and the included angle information being configured for indicating an intersection status between corresponding tangent lines of the every two adjacent roads; and
constructing the constraint condition based on the included angle information between the every two adjacent roads.

14. The device according to claim 13, wherein a road surface of the road comprises a left side sub-road surface and a right side sub-road surface, and the one or more processors are further configured to perform:
obtaining an included angle between a first road and a second road, wherein the first road and the second road are adjacent roads among the at least two roads;
obtaining a first included angle between the first road and a boundary line of a right side sub-road surface of the first road, obtaining a second included angle between the second road and a boundary line of a left side sub-road surface of the second road, and obtaining a third included angle between the boundary line of the right side sub-road surface of the first road and the boundary line of the left side sub-road surface of the second road; and
constructing the constraint condition based on the included angle between the first road and the second road, the first included angle, the second included angle, and the third included angle.

15. The device according to claim 14, wherein a sum of the first included angle, the second included angle, and the third included angle is less than or equal to the included angle between the first road and the second road.

16. The device according to claim 14, wherein the one or more processors are further configured to perform:
obtaining coordinates of a road shape point of the first road and coordinates of a road shape point of the second road; and
calculating the included angle between the first road and the second road based on the coordinates of the road shape point of the first road and the coordinates of the road shape point of the second road.

17. The device according to claim 14, wherein the first included angle is represented by road surface width information of the right side sub-road surface of the first road and an offset variable of the first road.

18. The device according to claim 14, wherein the second included angle is represented by road surface width information of the left side sub-road surface of the second road and an offset variable of the second road.

19. The device according to claim 12, wherein the one or more processors are further configured to perform:
determining a road level of the road based on the road information; and
determining the road surface width information of the road based on the road level of the road.

20. A non-transitory computer-readable storage medium, comprising instructions that, when being executed, causes a computer device to perform:
obtaining road information of a target intersection node, the road information being configured for indicating at least two roads related to the target intersection node;
determining road surface width information of roads based on the road information;
obtaining a constraint condition and a target function, the target function being configured for indicating a target area size of an intersection area of the target intersection node, the target function comprising an offset variable corresponding to a road of the at least two roads, the offset variable being configured for indicating a distance between the target intersection node and a tangent line of a corresponding road, the constraint condition being configured for indicating a limiting condition of the target area size, and the constraint condition comprising constraint relationships between corresponding offset variables of every two adjacent roads of the at least two roads;
determining an offset distance of the road based on the road surface width information of the road, the constraint condition, and the target function; and
generating the intersection area of the target intersection node in a map based on the road surface width information of the road and the offset distance of the road.
